(19) United States
(12) Patent Application Publication
(10) Pub. No.: US 2026/0323784 A1
(43) Pub. Date: Oct. 15, 2026

(54) HEATER FOR TEMPERATURE-CONTROLLED HEATING

(71) Applicant: Lummus Technology LLC, Bloomfield, NJ (US)

(72) Inventors: Baozhong ZHAO, Mahwah, NJ (US); Alejandro CARRILLO, New York, NY (US); Joseph G. GREZZO, Bethlehem, PA (US); Kandasamy M. SUNDARAM, Old Bridge, NJ (US)

(21) Appl. No.: 19/642,003

(22) Filed: Apr. 8, 2026

Related U.S. Application Data
(60) Provisional application No. 63/785,981, filed on Apr. 9, 2025.
(60) Provisional application No. 63/792,045, filed on Apr. 21, 2025.

(51) Int. Cl. H05B 3/78

(52) U.S. Cl. CPC H05B 3/78; H05B 2203/021; H05B 2203/022

(57) ABSTRACT

A heater for temperature-controlled heating includes a double tube assembly with an inner tube received within an outer tube and a space between the inner tube and the outer tube for the flow of a process fluid. A first heat source is associated with the outer tube and a second heat source is associated with the inner tube. The first and second heat sources provide heat input to the process fluid in the space between the outer and inner tubes. The second heat source may be positioned within an internal cavity or passageway of the inner tube. The first and second heat sources are an electrical heater, a non-electric heater, an external heater or external heat source, or a thermal fluid heat source and may be the same type of heat source or different from each other.

### BACKGROUND

### Technical Field

The present disclosure is generally directed to industrial heat exchange equipment and methods, and is particularly, but not exclusively, directed to a heater for temperature-controlled heating.

### Description of the Related Art

Heaters and heat exchangers for industrial applications are generally known with example types of heaters being fired and electric heaters. Conventional heaters irrespective of the heat source are designed for processing liquids or gas, or more generally, fluids with a low viscosity. There are number of challenges for processing and heating fluids with a high viscosity or fluids of any viscosity that are temperature sensitive using conventional techniques.

For example, a high viscosity fluid will have a relatively lower heat transfer coefficient than a low viscosity fluid such as water. Thus, when a high viscosity fluid is fed through a conventional heater or heat exchanger, a film will form on the outer surface of the material that is also known as a boundary layer. The film temperature will be extremely high because of the low transfer coefficient or slow rate of transfer of heat from the outer surface to the center of the high viscosity material. The high film temperature will cause degradation of the feedstock which can lead to fouling of the equipment, formation of material deposits in the equipment that result in additional maintenance and cleaning, and other issues. The same issues may be apparent for fluids of any viscosity that are temperature sensitive because application of an incorrect temperature can degrade the feedstock or cause other issues. Further, processing high viscosity fluids with conventional equipment typically results in an unacceptably high pressure drop through the heater, thus increasing operating cost and resulting in an overall less efficient process, among other design challenges.

Thus, it would be beneficial to have heater devices, systems, and methods that overcome the above and other challenges and disadvantages of known systems.

### BRIEF SUMMARY

The present disclosure is generally directed to a heat transfer assembly for a heater or a heat exchanger, such as a heating coil or a tube bundle as well as heaters or heat exchangers incorporating such heat transfer assemblies and providing heat input from various sources (i.e., fuel firing, electricity, thermal fluid, a hybrid heater with heat input from fuel firing and electricity, or any combination thereof). The heat transfer assembly includes double tubes with a first, outer tube and a second, inner tube received inside the outer tube. There is a gap or space between the outer and inner tubes for flow of a process fluid through the gap or space between the outer and inner tubes. A first heat source or heating element is associated with the outer tube and a second heat source or heating element is associated with the inner tube. The heat sources may be electrical heating elements, non-electrical heating elements or external heat sources, or thermal fluid heat sources. The first and second heat sources may be the same, or different to provide flexibility in operation and apply the technology to a broader range of processing requirements. Despite a preference toward including both the first and second heat sources, some examples described herein employ only one of the first and second heat sources while the other is omitted (i.e., only a first heat source or only a second heat source).

The first heating element or heat source is positioned to provide heat input to an external or outer surface of the outer tube. The second heating element or heat source is positioned or arranged to provide heat input to an interior wall of the inner tube such that the second heating element or heat source provides heat input to the interior of the double tube assembly. The use of double tubes and external and internal heat input offers a large amount of heating surface area and large equivalent hydraulic diameter while minimizing thickness of the laminar flow boundary in the gap or spaced between the outer and inner tubes. For example, the heating surface area of such a double tube may be twice or approximately twice the heating surface area of a standard single tube that does not have a gap between inner and outer tubes. The concepts of the disclosure also provide various solutions for accessing and cleaning the components of the double tubes to reduce the frequency of maintenance and maintenance cost. The double tube assembly provides for higher average heat flux and less parallel streams such that overall, the design is more compact and will have a lower cost.

The present disclosure is not limited to the example implementations, benefits, and advantages provided above. Additional features, benefits, and advantages are explained below in connection with the drawings.

### BRIEF DESCRIPTION OF THE SEVERAL VIEWS OF THE DRAWINGS

FIGS. 1A-1C are schematic views of an implementation of a heater coil with a double tube according to the present disclosure.

FIGS. 2A-2C are schematic views of various heat sources for providing heat input to the heater coil of any one of FIGS. 1A-1C.

FIG. 2D is a schematic view of the heater coil of any one of FIGS. 1A-1C with spiral vanes or fins for guiding process fluid flow.

FIGS. 3A and 3B are schematic views of the heater coil of any one of FIGS. 1A-1C with several double tubes.

FIG. 4 is a schematic view of an implementation of a heater including double tube coils according to the present disclosure.

FIGS. 5A and 5B are schematic views of an implementation of a heat exchanger with a double tube for processing two fluids according to the present disclosure.

FIGS. 6A and 6B are schematic views of the double tube of the heat exchanger of either of FIGS. 5A and 5B including spiral fins for guiding fluid flow.

FIG. 7A is a schematic view of the double tube of the heat exchanger of either of FIGS. 5A and 5B with a spacer between the inner and outer tubes.

FIG. 7B is a schematic view of the double tube of the heat exchanger of either of FIGS. 5A and 5B with tube supports supporting the double tubes.

FIG. 8 is a schematic view of the heat exchanger of either of FIGS. 5A and 5B with external heat input to the heat exchanger.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide heater or heat exchanger devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure.

Unless the context clearly dictates otherwise, the phrase “high viscosity” when used to describe a fluid means a fluid with a viscosity of at least 20 centipoise (cP) or 20 millipascal-seconds (mPa.s) or higher. The phrase “low viscosity” when used to describe a fluid means a fluid with a viscosity of less than 20 cP. For reference, the viscosity of water is approximately 1 cP such that a high viscosity fluid herein has a viscosity at least 20 times greater than that of water. The term “heater” is construed broadly to include any device capable of transferring heat to a process fluid. The term or phrase “double tube” refers to a tube assembly for conveying fluids that includes an inner tube inside of an outer tube with a space or gap between the inner tube and outer tube for the flow of fluid. As such, a “double tube” of the type described herein includes an outer tube wall and a separate inner tube wall, which can be distinguished from a standard single tube with only one tube wall defining the circumference of the single tube.

A heater, such as the type used in petrochemical processing, typically contains a radiant section with radiant coil(s) or both radiant and convection sections with coils in both the radiant and convection sections (i.e., radiant coils and convection coils, respectively). A process fluid enters the heater at the coil inlet and flows through the convection coils and/or the radiant coils. Heat input is provided to the process fluid in the coils by a heat source to raise a temperature of the process fluid to the desired temperature for further processing, such as in a reactor for chemical reactions or a column for material separation. Such heat input can be radiant heat, convective heat, conductive heat, or a combination thereof, from a number of different heat sources, including but not limited to fuel firing, electricity, thermal fluid, hybrid heat input from fuel firing and electricity or any combination of two heat sources, or any combination thereof. The coils in a heater typically consist of single-walled tubes or single tubes with the process fluid flowing inside the tubes. Heat exchangers exchange heat between two process fluids through indirect heat transfer. Heat exchangers include tubes arranged in a bundle inside of a shell or pressure vessel with a first process fluid flowing inside the tubes and a second process fluid flowing through the shell around the outside of the tubes. As a result, heat is exchanged between the first and second process fluids through indirect heat transfer via the tubes.

When a process fluid flows through a tube, the fluid will have a boundary layer at the interface between the fluid and the tube internal wall where the fluid will have a much lower velocity compared with the bulk flow through the tube (i.e., the remainder of flow toward a center of the tube and not proximate the tube wall). In general, the fluid in the boundary layer exhibits characteristics of a laminar flow while the bulk flow may be in highly turbulent flow. The velocity of the fluid at the boundary layer may also be referred to herein as a flow boundary. There is also a temperature boundary where the temperature will have a gradient at the boundary or interface between the tube and the fluid while the remaining bulk flow has relatively uniform temperature. The flow boundary and the temperature boundary may coincidently have the same geometry or a different geometry. Due to a typical lack of mixing inside the flow boundary or of the boundary layer, the heat transfer through the boundary layer is mainly accomplished by conductive heat transfer. Therefore, the process fluid temperature next to the tube internal surface (i.e., the film temperature), will be higher than the process fluid bulk temperature (i.e., temperature of remainder of flow excluding the boundary) for heat receiving services, which has the challenges and disadvantages above. One option for reducing film temperature is to increase heating surface area to reduce the heat flux. But this may result in a higher process pressure drop because of increased contact between the fluid and the larger heating surface area (i.e., increase in size of the boundary layer), among other factors, and thus a higher overall operation cost.

Additional parallel flow passes or larger diameter tubes are utilized in conventional solutions to balance heat flux (and therefore film temperature) and pressure drop. But there is lower flow velocity with more parallel flow, which results in a thicker boundary layer and higher film temperature such that conventional techniques do not provide acceptable solutions. In addition, larger diameter tubes result in a larger temperature difference or gradient between the film temperature and the bulk fluid temperature. Balancing these competing considerations with conventional techniques results in large, complex, and costly designs such that conventional solutions have thus far proved inadequate to overcome the above challenges and effectively heat a variety of process fluids, and particularly those that would benefit from temperature-controlled heating. For example, when conventional techniques are applied to processing high viscosity feedstock or high viscosity process fluids, the high viscosity leads to high resistance to the flow and high film temperature, which has the disadvantages above. To control the film temperature using conventional techniques, a large amount of heating surface area is required, and it may become necessary to use a heater instead of a heat exchanger given that the heating surface area needed will result in a heat exchanger that is too large and impractical.

Overall, the concepts of the disclosure are directed to heaters and heat exchangers that are capable of processing high viscosity feed stock or high viscosity process fluids in laminar flow (or flow with a low Reynold’s number) at low flow velocities by reducing the film temperature while maintaining acceptable or desirable process pressure drop. In other words, the concepts of the disclosure provide a solution that balances the above design considerations in a cost-effective design. The disclosure contemplates a heater with one or more coils including so-called “double tubes” or tubes that have two concentric passages, as further described below. Double tubes enable an increase in heating surface area (i.e., approximately twice the surface area of conventional single-walled tubes) to lower the process fluid film temperature while also reducing pressure drop relative to conventional solutions. The techniques discussed herein can be applied equally to heat exchangers to provide similar and additional advantages for indirect heat exchange between process fluids. In addition, the concepts of the disclosure also enable tight temperature control in applications where the feedstock or process fluid(s) is temperature sensitive.

The concepts discussed herein are particularly advantageous for bio-fuel or bio-fluid feedstocks that have high viscosity and a low film temperature requirement, as well as for any process fluid where it is advantageous for tight temperature control of the fluid or where the fluid is temperature sensitive. The intended application of the concepts herein is not limited to the above and the techniques discussed can be applied to any process fluid that would benefit from improved heat transfer irrespective of viscosity, temperature sensitivity, and other characteristics of the fluid or the process.

In the following figures, only the tubes and heat transfer structures are shown and described to avoid obscuring the concepts of the disclosure. Background structure such as a shell or pressure vessel around the coils, upstream and downstream structures in the broader system flow (i.e., background features of the heater or heat exchanger), and other aspects are omitted.

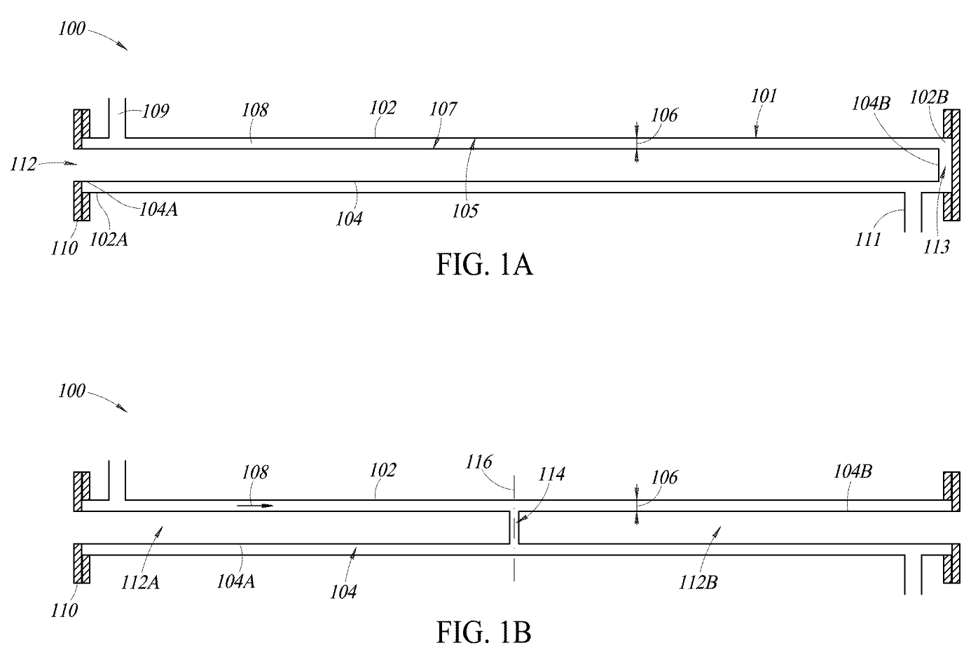

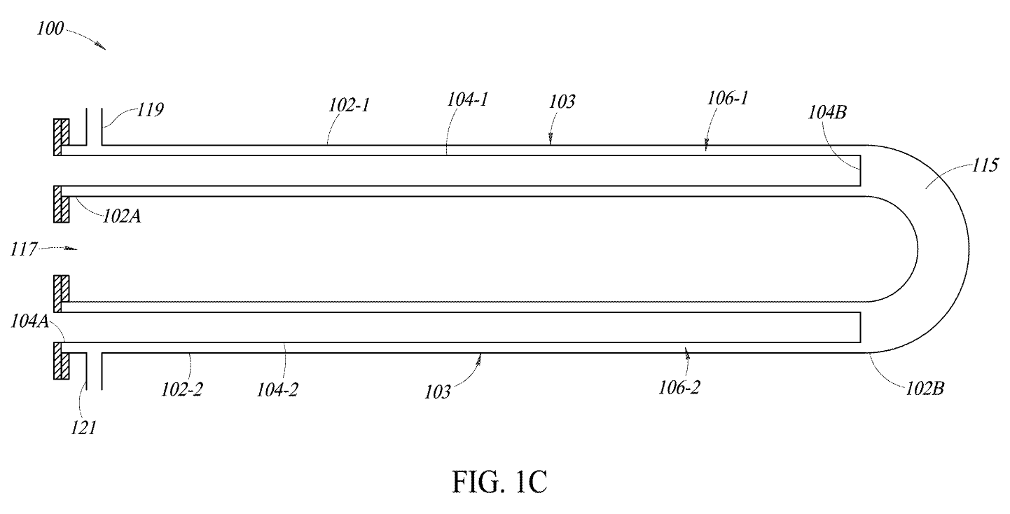

FIGS. 1A-1C are schematic views of an implementation of a double tube coil 100 for a heater according to the present disclosure. Beginning with FIGS. 1A and 1B, the double tube coil 100 includes a first, outer tube 102 and a second, inner tube 104 received within the first, outer tube 102. The outer and inner tubes 102, 104 cooperate to define a double tube 101. For simplicity, FIGS. 1A-1C show only a single double tube 101, although the coil 100 may include more than one double 101, as described below. Each of the tubes 102, 104 is a standard single tube, meaning a tube with a single outer circumferential wall and a longitudinal axial bore therethrough for the flow of fluid inside the bore. The inner tube 104 is received within or inside the axial bore of the outer tube 102 to form the double tube assembly. The first tube 102 has a larger tube diameter than the second tube 104, and specifically, an inner diameter of the first tube 102 is greater than an outer diameter of the second tube 104. As a result, there is a gap or space 106 between an interior wall or surface 105 of the first tube 102 and an external wall or surface 107 of the second tube 104.

The outer diameter of the tubes 102, 104 can be selected from conventional and available sizes in the industry including at least 0.25 inches, 0.375 inches, 0.5 inches, 0.625 inches, 0.75 inches, 0.875 inches, 1 inch, 1.125 inches, 1.25 inches, 1.5 inches, 1.75 inches, 2 inches, 2.25 inches, 2.5 inches, 2.75 inches, 3 inches, 3.25 inches, 3.5 inches, 3.75 inches, 4 inches, 4.25 inches, 4.5 inches, 4.75 inches, 5 inches, and 5.25 inches. Other sizes or outer diameters are contemplated, including any available size or any size that can be custom fabricated provided that the inner tube 104 can be received inside the outer tube 102 with a gap or space 106 therebetween to form a double tube. Further, the thickness or gauge of the walls of the tubes 102, 104 can be selected to be any whole integer value between Birmingham Wire Gauge (BWG) 00-24 and other thicknesses or gauges. The outer diameters of the tubes 102, 104 are preferably selected such that the gap or space 106 is at least 0.25 inches although the dimensions or size of the gap or space 106 may generally be selected. For example, and for purposes of original disclosure, the gap or space 106 can be any value up to two decimal places in the range of 0.1 inches to 5 inches. The disclosure of this range thus provides support for a gap or space of 0.5 inches as well as 1.25 inches, among any other values in the range. The gap 106 provides a conduit for flow of a process fluid 108 therethrough and as further described herein.

Ends of the first and second tubes 102, 104 are coupled together in a fluid-tight manner to contain the fluid 108 in the gap 106. The connection between ends of the tubes 102, 104 is preferably a flanged connection via flanges 110 that is removable to allow for cleaning and maintenance. The flanges 110 are coupled to each of the first and second tubes 102, 104 and the flanges 110 are coupled to each other to establish the flanged connection. Other connections are contemplated and suitable for the concepts of the disclosure, such as a welded connection in a non-limiting example. Each of the first and second tubes 102, 104 are hollow or at least partially hollow meaning that they have a longitudinal axial bore extending along at least part of, or all of, the length of the tubes 102, 104. The second tube 104 is received inside the bore of the first tube 102, as shown. The hollow second tube 104 defines an internal cavity or passageway 112 that is utilized for heating or heat transfer, as further described herein.

FIGS. 1A and 1B also illustrate variations on the second, inner tube 104. Specifically, the second tube 104 can be manufactured and installed as a single, continuous, integral, unitary structure from one outer end to the opposite outer end as shown in FIG. 1A. In such an example, the internal passageway 112 is likewise a continuous, uninterrupted flow path through the second tube 104. The coil 100 shown in FIG. 1A includes the inner and outer tubes each having respective first and second ends 102A, 102B, 104A, 104B. In more detail, the outer tube 102 includes opposite first and second outer ends 102A, 102B adjacent or near the flanges 110 and the inner tube 104 includes opposite first and second outer ends 104A, 104B adjacent or near the flanges 110. At the first ends 102A, 104A of the tubes 102, 104 (i.e., the left end in the orientation of FIG. 1A), the tubes 102, 104 are fluidically isolated from each other except for the flow through the gap or space 106 described above. The first end 104A of the inner tube 104 is open to provide access to the passageway 112 while part of the first end 102A of the outer tube 102 (i.e., the additional diameter of the outer tube 102 beyond the inner tube 104) is closed by the respective flange 110 to seal the gap or space 106. One of the flanges 110 overlies and closes the gap or space 106 at the first ends 102A, 104A of the tube 102, 104 such that when the two flanges 110 are coupled together, a fluid tight seal is established to contain fluid in the gap or space 106.

At the second ends 102B, 104B of the tubes 102, 104 (i.e., the right end in the orientation of FIG. 1A), the outer tube 102 is completely closed by the corresponding flange 110, meaning the flange 110 extends across an entire diameter and circumference of the outer tube 102 such that when the flanges 110 are coupled together, a fluid tight seal of the gap or space 106 is established. The flanged seal 110 on the right or second ends 102B, 104B as shown in FIG. 1A may be replaced with a cap, seal, or other structure to close the ends 102B, 104B and force the process fluid 108 to move into the next tube in the coil 100 through a jump-over 111, as shown in FIGS. 1A and 1B, or a return bend as in FIG. 1C. The inner tube 104 may be manufactured to be closed at the second end 104B or closed with a cap, seal, flange or other structure to prevent fluid flow into the passageway 112 inside the inner tube 104. The inner tube 104 has a length that is shorter or less than a length of the outer tube 102 such that at the second ends 102B, 104B, there is a further gap or space that is a return conduit or return header 113 for fluid flow around the closed second end 104B of the inner tube 104. The further gap or space 113 also provides room for differential thermal expansion between the outer tube 102 and the inner tube 104.

In some non-limiting examples, the return header 113 can have the same size or a different size than the gap or space 106 depending on the anticipated thermal expansion to account for in the design. In particular, the return header 113 may be larger than the gap or space 106 to account for differential thermal expansion of the inner tube 104 when the system is not in use or is resting at environmental temperature. In operation, thermal expansion of the return header 113 may result in the return header 113 being larger, the same or approximately the same, or smaller than the size of the space or gap 106. Unless otherwise indicated, the return header 113 can be selected to have any of the dimensions disclosed above for the gap or space 106. Thus, process fluid can flow around an entirety of the inner tube 104 from an inlet 115 into the gap or space 106, through the gap or space 106 and return header 113, and to the jump-over 111 where the fluid exits the coil 100. There is no fluid flow through the open first end 104A of the inner tube 104.

Alternatively or in addition, the second, inner tube 104 can include two, separate pieces 104A, 104B or two separate tubes 104A, 104B. The separate pieces 104A, 104B each have a length that may be half or less than half of a length of the first tube 102 such that there is a conduit 114 between the second tubes 104A, 104B within the first tube 102 at the center of the coil 100 (or another selected location spaced from the center) instead of at the second ends 102B, 104B as in FIG. 1A. In other words, the conduit 114 in FIG. 1B replaces the return header 113 of FIG. 1A. FIG. 1B is a schematic cross-sectional view such that the conduit appears as a 90 degree turn around the inner ends of the second tubes 104A, 104B. In practice, the tubes 102, 104A, 104B are circular or cylindrical in shape such that the conduit 114 is an opening around the entire inner circumference of the first tube 102 and between the second tubes 104A, 104B. In FIG. 1B, the inner ends of the second tubes 104A, 104B are closed or capped to prevent the fluid 108 from entering the passageway 112 inside each of the second tubes 104A, 104B. Further, it is noted that the internal passageway 112 in the arrangement of FIG. 1B is bifurcated into two separate and fluidly isolated cavities 112A, 112B inside each of the respective second tubes 104A, 104B. The cavities 112A, 112B are each open at one, outer end and closed at the other, inner end at the conduit 114. As a result, the cavities 112A, 112B are separated or spaced apart from each other by the conduit 114. The conduit 114 can have a selected size from any of the dimensions disclosed herein for the gap or space 106 of FIG. 1A and may have a smaller, same, or larger size than the gap or space 106 and/or return header 113.

The implementation in FIG. 1B provides for a simplified design that also accounts for thermal expansion during operation of the heater employing the double tube coil 100 because the second tubes 104A, 104B can expand into the conduit 114. In other words, the conduit 114 provides room or space for thermal expansion of the second tubes 104A, 104B. Preferably, the conduit 114 is located centrally with respect to the first tube 102, meaning aligned on a central vertical axis through the first tube 102, as represented by dashed line 116. The conduit 114 may be instead located at a selected location anywhere along the first tube 102 by varying a length of the second tubes 104A, 104B. In addition, more than one conduit 114 is contemplated in some implementations. In both FIGS. 1A and 1B, the first, outer tube 104A is a single, continuous, integral, unitary structure that receives the second tube 104 or second tubes 104A, 104B. Other configurations of the first and second tubes 102, 104 are possible and contemplated herein.

FIG. 1C illustrates a further variation of the double tube coil 100 that includes two separate double tube assemblies 103 each including a respective first tube 102-1, 102-2 and second tube 104-1, 104-2. In other words, the coil 100 of FIG. 1C includes two repeated double tube assemblies of the type shown in FIG. 1A with one assembly 103 positioned above or side by side the other assembly 103. Preferably, the double tube assemblies 103 are parallel to each other and have similar lengths, sizes, and dimensions, although the same is not required and the assemblies 103 may be different as well as in a different angular orientation relative to each other. The assemblies 103 are joined together in fluid communication at the respective second ends 102B, 104B of the tubes 102-1, 102-2, 104-1, 104-2 by a return header 115 instead of by the flanges 110 as in FIG. 1A. In the implementation of FIG. 1C, the return header 115 is a curved tube that turns 180 degrees (or some other selected degree of turn based on the orientation of the tubes 102-1, 102-2, 104-1, 104-2) to connect the respective second ends 102B, 104B of the tubes 102-1, 102-2, 104-1, 104-2. The combination of the assemblies 103 and the return header 115 forms a so-called “hair-pin” coil or arrangement with two straight, parallel sections (the assemblies 103) and one curved section (the return header 115) joining the two straight, parallel sections in an overall “U” or hairpin shape.

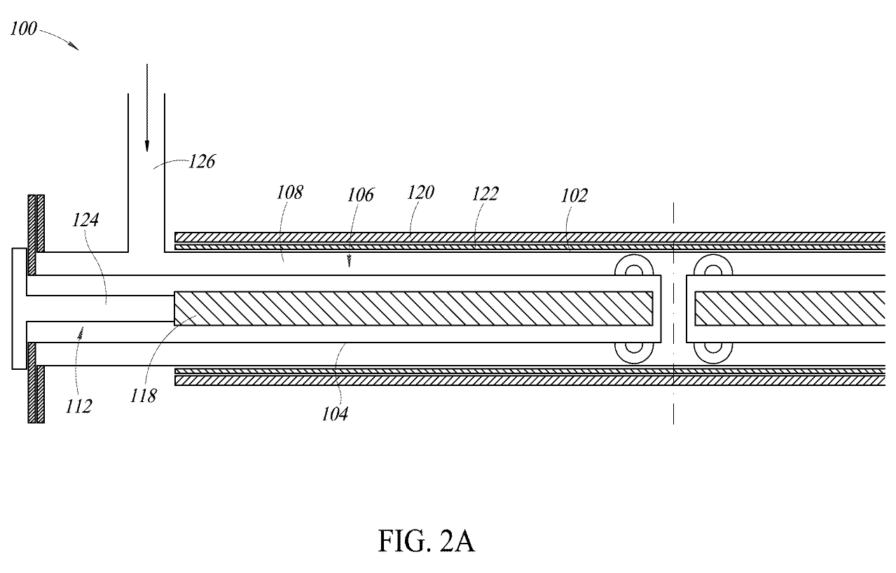

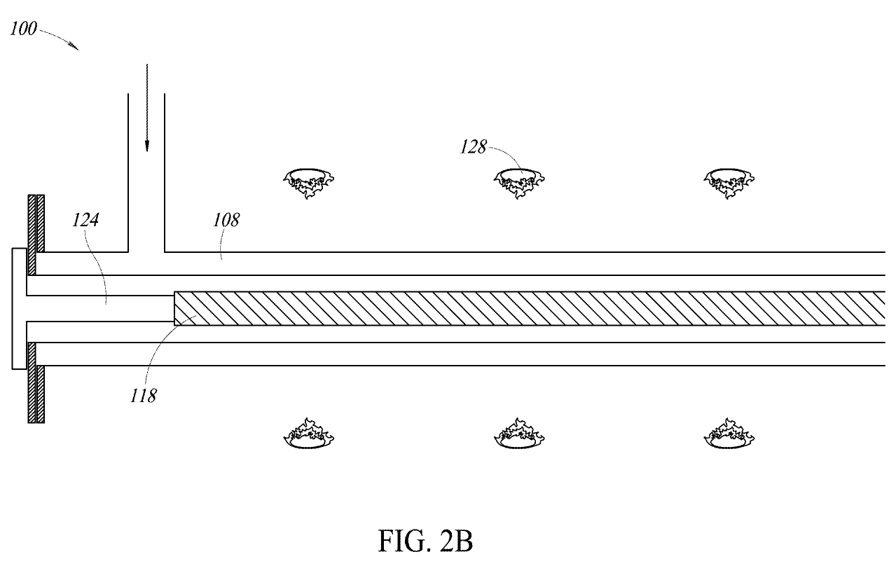

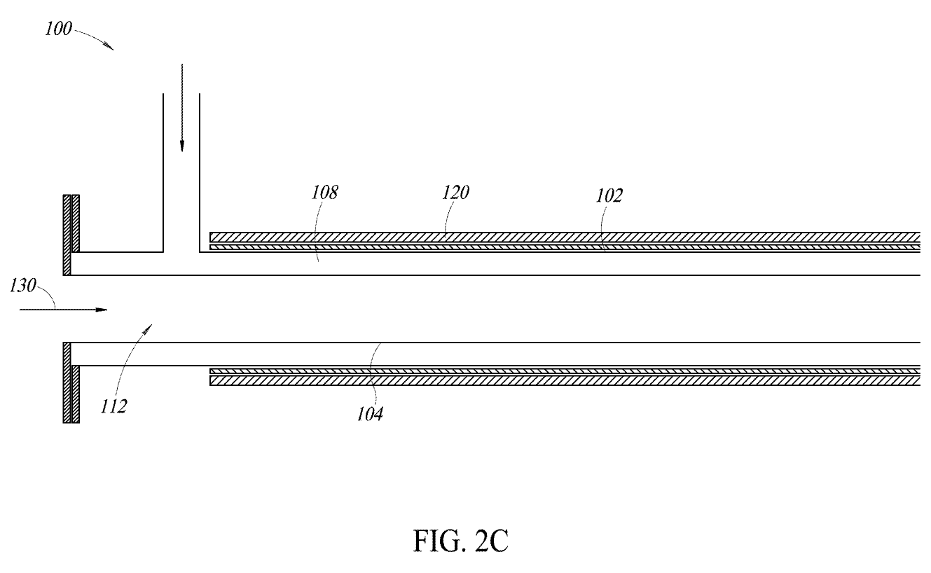

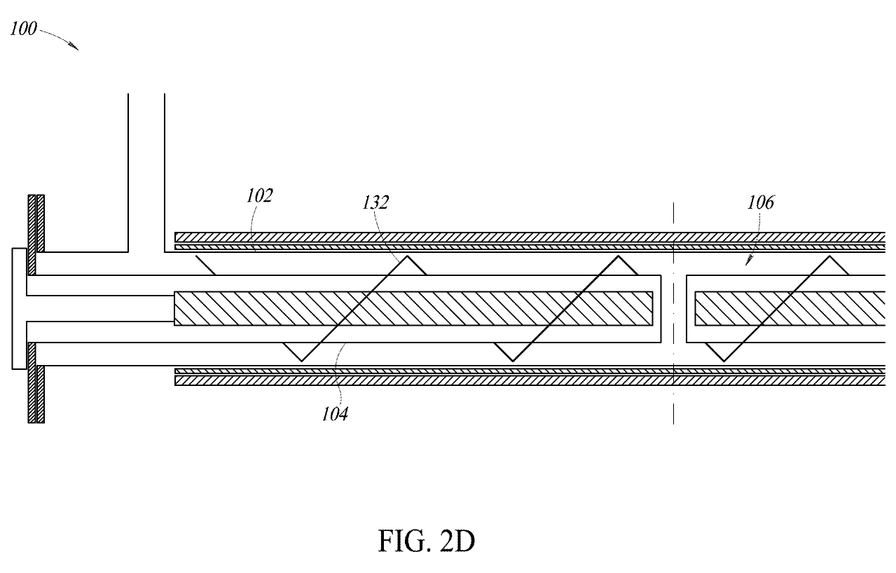

The return header 115 preferably has a diameter that is equal to a diameter of the outer tubes 102-1, 102-2 for ease of assembly and manufacturing, although the return header 115 can also be eccentric (meaning having a larger or small diameter) to the outer tubes 102-1, 102-2. The return header 115 is a continuous, uninterrupted conduit for flow of process fluid from the gap or space 106-1 of the first assembly 103 to the gap or space 106-2 of the second assembly 103. There is a central space 117 between the assemblies 103 and the return header 115 that may be empty or one or more heating methods or elements, such as any of those described with reference to FIGS. 2A-2C may be positioned in the space 117 to improve heat transfer to the coil 100 of FIG. 1C, and particularly to outer surfaces of the outer tubes 102-1, 102-2 that face toward the space 117. Further, the coil 100 of FIG. 1C has a process fluid inlet 119 at the first ends 102A, 104A of the tubes 102-1, 104-1 of the first assembly 103 and a process fluid outlet 121 at the first ends 102A, 104A of the tubes 102-2, 104-2 of the second assembly 103 such that process fluid flows through the entire length of the tubes 102-1, 102-2, 104-1, 104-2 and the return header 115 as it traverses the coil 100 to maximize heat transfer. This is different than the arrangement of the coil 100 in FIGS. 1A and 1B, where the coils 100 have an inlet at the first ends 102A, 104A of the tubes 102, 104 and an outlet at the second ends 102B, 104B of the tubes 102, 104.

The arrangement of the inlets and outlets at opposite ends of the tubes 102, 104 as in FIGS. 1A and 1B may be particularly beneficial for interconnecting a number of repeated tube assemblies in a broader heater or heat exchanger assembly, as described herein, while the arrangement of the coil 100 in FIG. 1C is particularly beneficial to maximize heat transfer irrespective of whether the coil 100 of FIG. 1C is a single unit or is one of a repeated number of coils 100 in a larger assembly. The arrangement of FIG. 1C is particularly beneficial for heat transfer because the inlet and outlet 119, 121 located at the same side of the “U” or hairpin arrangement increases residence time in the coil 100 relative to the coils 100 in FIGS. 1A and 1B. In FIG. 1C, the fluid needs to flow from the outlet 119 and through both double tube assemblies 103 and the return header 115 before exiting at the outlet 121 in a double pass arrangement whereas in FIGS. 1A and 1B, the fluid flows from one end of the tubes 102, 104 to the other in a single pass arrangement. Such increased residence time and additional contact with heating surface area in FIG. 1C improves heat transfer. Despite the arrangement of FIG. 1C being advantageous for heat transfer, the coils 100 of FIGS. 1A and 1B provide the advantages discussed herein and may be advantageous over the coil 100 of FIG. 1C in some applications. While each of FIGS. 1A-1C show variations of a coil 100, it is noted that implementations of coils of the type described herein can include any combination of features from FIGS. 1A-1C even if not expressly shown an described. Thus, FIGS. 1A-1C should not necessarily be construed as separate and independent implementations, but rather, as demonstrating some of the design options available that can be used in different configurations disclosed herein.

FIGS. 2A-2D are schematic illustrations of various heating methods or techniques that can be used or applied to provide heat input to the fluid 108 in the double tube coil 100 of any of FIGS. 1A-1C. Beginning with FIG. 2A, illustrated therein is an implementation where the heater employing the coil 100 is an electric heater with inner electric heating elements 118 inside the passageway or cavity 112 of the second tube 104 and outer electric heating elements 120 around the outer surface of the first tube 102 for heating the coil 100 and process fluid 108. Accordingly, in FIG. 2A, electric heaters or heating elements 118, 120 provide simultaneous heat input from outside of the outer tube 102 to the process fluid 108 and from inside the inner tube 104.

The coil 100 in FIG. 2A also includes an additional protective layer 122, such as of a ceramic material or others, between the outer heating element 120 and the first tube 102 as an insulator to prevent shorting of the outer heating element 120 but that also provides the benefit of even heat input. A similar protective layer may optionally be provided on the inner wall of the inner tube 104. The inner heating element 118 may be mounted on a rod or other support structure 124 for removable insertion into the passageway or cavity 112. Further, there may or may not be an air gap or space between the inner heating element 118 and the internal wall of the second tube 104 in various implementations meaning that the heating element 118 can be in contact with the internal wall of the second tube 104 or can be spaced from the internal wall of the second tube 104. The inner heating element 118 may be provided as two separate heating elements, such as one for each cavity 112 of the second tubes 104A, 104B as in the coil 100 of FIG. 1B. The inner heating element 118 may also be a single piece for the second tube 104 installed in only the open end of the second tube 104, such as the continuous inner tube 104 in FIG. 1A. FIG. 2A further illustrates that the coil 100 includes an inlet 126 for the process fluid 108 that is in fluid communication with the first tube 102 and the space 106 between the first tube 104 and the second tube 104. In an implementation, electrical heating provides the most uniform heat flux and reduces the peak tube metal temperature, which results in the lowest possible film temperature of the feedstock or process fluid for a given coil design. Thus, electrical heating is a preferred implementation, although there are other viable alternatives that may be preferred for different applications, as below.

FIG. 2B illustrates that the coil 100 and process fluid 108 can be heated by other heat sources instead of electrical heating, including at least fuel firing or hot gas stream by either radiant heat transfer or convection heat transfer. This is represented schematically in FIG. 2B with external burners or heaters 128. The number and arrangement of burners 128 relative to the coil 100 can generally be selected based on the overall heater design. In an implementation, the only heat input provided to the coil 100 is from the burners 128 or non-electrical sources. In such an example, hot gas can flow inside the passageway 112 inside the inner tube 104 and provide some of the benefits discussed herein. Further, other arrangements where non-electrical heat input is provided inside the inner tube 104 are contemplated to provide benefits and advantages in terms of heat input that are similar to using at least one electric heat source. Additionally or alternatively, the burners 128 can also be used with the inner electrical heating element 118 to provide heat input from inside the inner tube 104 and thus provide the benefits and advantages discussed herein regarding providing heat input to the coil 100 from all sides.

FIG. 2C illustrates a further alternative for heating the coil 100 and process fluid 108 using a further process fluid represented schematically by arrow 130. Heating using the further process fluid 130 may be accomplished by flowing the further process fluid 130 through the passageway 112 inside the second tube 104 such that the process fluid 108 is heated by convection or indirect heat transfer. The further process fluid 130 may be provided at a selected temperature for heating the process fluid 108 and may be generated by other downstream or upstream processes in the system incorporating the coil 100. The coil 100 of FIG. 2C also includes heat input to the outer tube 102 from any source described herein, including at least the outer electrical heating element 120, a non-electrical outer heating element such as burners 128, and/or heating the first, outer tube 102 and process fluid 108 with additional process fluid.

As should be apparent from the above, the disclosure contemplates any number of different variations on heating the coil 100 and process fluid 108. For example, the heating may be accomplished with electric only heating, with fuel firing or hot gas stream only, by heat transfer fluid only, or with any combination thereof. Importantly, each of the considered variations includes heating both the outer tube 102 and the inner tube 104 of the coil simultaneously using the same type or a different type of heat source depending on the application. Further, the system incorporating the coil 100 has the flexibility to operate with heat input to the outer tube 102 or inner tube 104 only at certain times, and/or with heat input to both the outer and inner tubes 102, 104 at certain times. Depending on the type of heating, this would allow the heater incorporating the coil to operate fully electric, fully by fuel firing (or by some other heating method), or any combination electric and fuel firing at different times of the day, which allows the heater to take advantage of flexible or varying electricity pricing throughout the day and lower overall operation cost while still providing the benefits described herein as well as environmental benefits for reduced fuel firing to provide the needed heat input to the system. Thus, the heater may be a hybrid heater in the sense that the heating method is flexible and selectable between different heating methods.

FIG. 2D illustrates that the coil 100 further includes spiral vanes or fins 132 in the gap or space 106 between the first outer tube 102 and the second inner tube 104. The spiral vanes or fins 132 can be formed on and/or coupled to either or both of the first and second tubes 102, 104. The spiral vanes or fins 132 can be provided in a helical pattern to induce helical flow with a selected spacing between each of the vanes or fins 132 and a selected pitch angle for each of the vanes or fins 132 that may be consistent for all vanes or fins 132 or may be different for each one or more of the vanes or fins 132. The spiral vanes or fins 132 can be provided in a single helical arrangement as shown in FIG. 2D, or multiple spiral vanes or fins 132 can be provided in a double or triple helix, among other possible configurations.

The spiral vanes or fins 132 promote mixing, change the boundary layer condition, and increase the heat transfer coefficient, all of which help reduce the film temperature. In implementations where the spiral vanes or fins 132 are coupled to or a part of the inner tube 104, the spiral vanes or fins 132 can also be used as a cleaning tool to clean the fouling to the internal surface of the outer tube 102 by disconnecting the end flanged connection and turning the inner tube 104 as needed such that the vanes or fins 132 scrape along the internal surface of the outer tube 102. Once the outer tube 102 internal surface is cleaned, the inner tube 104 can be removed for cleaning of the outer and internal surfaces of the inner tube 104. Further, the vanes or fins 132 may be spaced from either of the internal surface of the outer tube 102 or the outer surface of the inner tube 104 depending on the size of the vanes or fins 132 and how they are mounted (i.e., attached to the inner tube 104 or the outer tube 102) or the vanes or fins 132 may be in contact with either or both of the internal surface of the outer tube 102 or the outer surface of the inner tube 104.

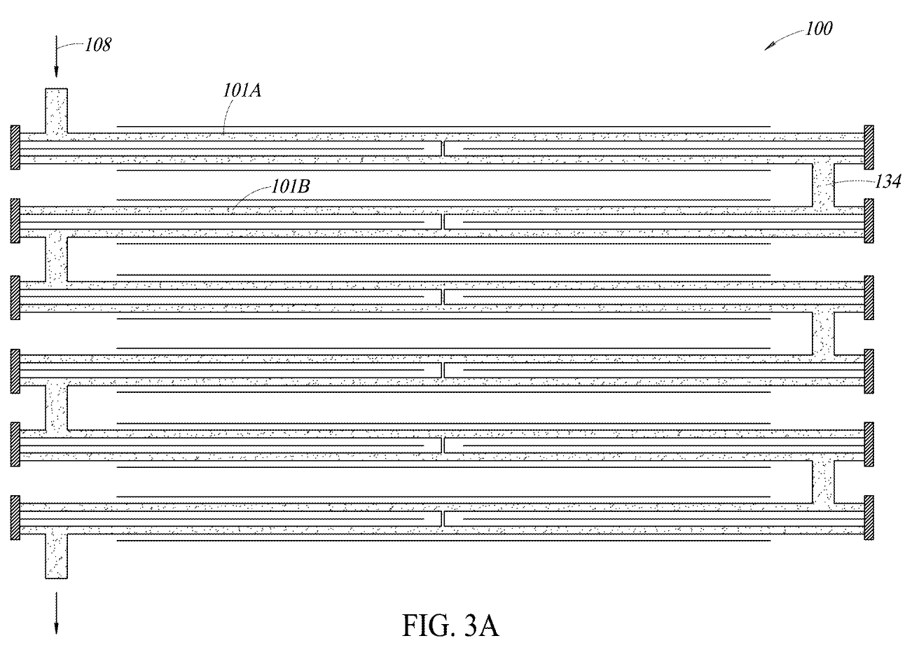

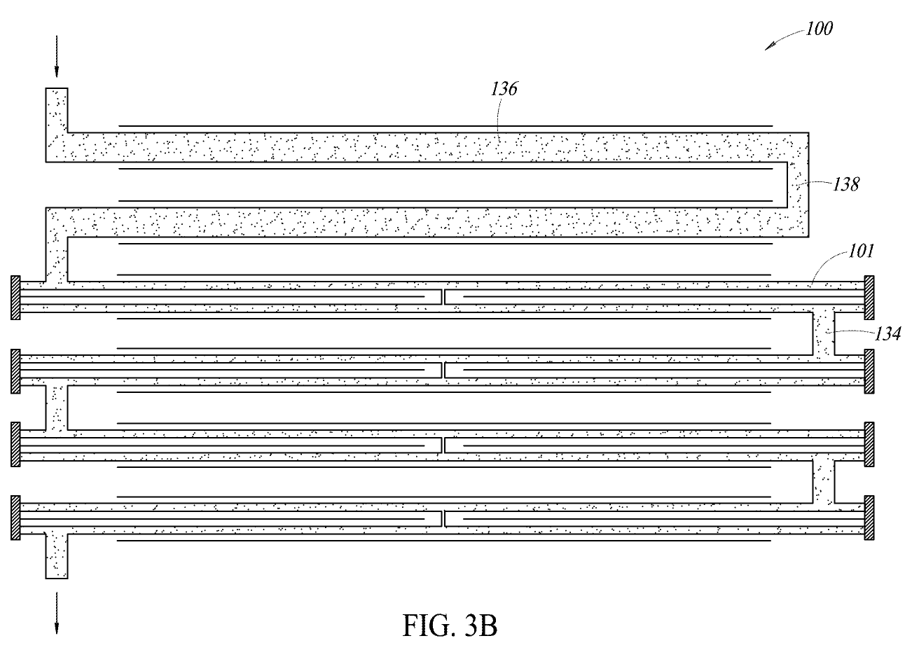

FIGS. 3A and 3B are schematic views of the coil 100 including multiple double tubes 101 of the type described above. The coil 100 of FIGS. 3A and 3B may include any of the double tubes 101 described above with reference to FIGS. 1A-2D. In other words, while FIGS. 1A-2D illustrate a simplified view of the coil 100 with only one double tube 101 including outer and inner tubes 102, 104 to emphasize features of the disclosure, FIGS. 3A and 3B provide an implementation of the coil 100 with multiple double tubes 101 to schematically illustrate how the coil 100 is implemented in practice.

Starting with FIG. 3A, illustrated therein is the coil 100 including multiple double tubes 101 that each include the features discussed herein, unless otherwise noted. The coil 100 consists of a number of double tubes 101 with the number generally be selectable based on the intended processing application or preferred design for different process fluids. FIG. 3A includes labels for double tubes 101A, 101B for clarity. Each double tube 101 is connected or in fluid communication with the other double tubes 101 through a jump-over 134, which may be a further tube or pipe interconnected proximate ends of successive double tubes 101. In particular, in the coil 100 of FIG. 3A, the process fluid 108 enters an inlet at one end of a first double tube 101A, flows through and is heated across the first double tube 101A, exits the first double tube 101A at a first jump-over 134 at the other, opposite end of the first double 101A where it then enters a second double tube 101B and flows to the opposite end of the second double tube 101B and so on to an outlet of the coil 100 for discharging the heated process fluid 108. In this way, the process fluid 108 flows from side to side or end to end through each of the double tubes 101 in the coil 100 to maximize heat transfer in a serpentine arrangement where the fluid 108 changes direction between each of the double tubes 101 (i.e., flows to the right in first double tube 101A, flows to the left in second double tube 101B, flows to the right again the next double tube 101, etc.).

FIG. 3B illustrates the coil 100 including a combination of double tubes 101 and single or standard tubes 136. The double tubes 101 may be used to implement the entire coil 100, as in FIG. 3A or may be in only part of the overall coil 100, such as at the beginning, middle, or end of the fluid flow path through the coil 100, as well as anywhere in between the beginning, middle, and end of the fluid flow path through the coil 100. FIG. 3B specifically illustrates the double tubes 101 at the end of the flow path through the coil 100 as a non-limiting example with a single tube 136 upstream of the double tubes 101 relative to a direction of fluid flow through the coil 100. The single tube 136 may have a similar configuration as the double tubes 101 in the sense that the fluid 108 flows from end to end in a serpentine arrangement or may have a different configuration, such as parallel flow in a number of single tubes 136, only one single tube 136 that does not change a direction of flow of the fluid 108, and others. Further, the connections between the single tubes 136 and/or the double tubes 101 may be jump-overs 134 as described with reference to FIG. 3A or may include a return bend 138 instead of the jump-over 134. Shown in a non-limiting example in FIG. 3B is the single tube 136 including the return bend 138 while the double tubes 101 include jump-overs 134. Any combination of return bends 138 and jump-overs 134 or return headers 113 can be used.

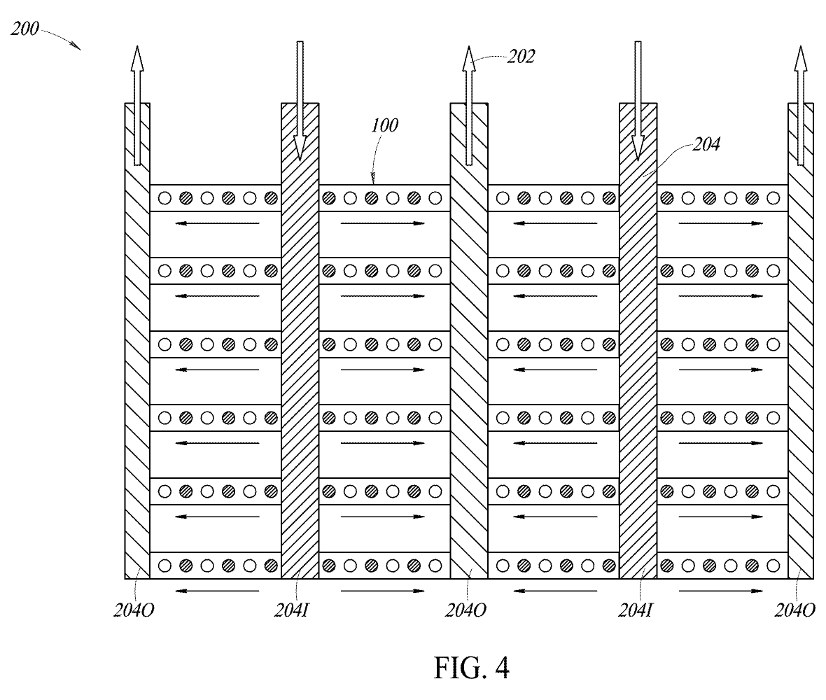

FIG. 4 is a schematic view of a heater 200 including multiple coils 100 of the type described above. Specifically, feedstock or process fluid 202 (flow represented schematically by arrows 202) flows through manifolds 204 that distribute the feedstock or process fluid 202 to individual coils 100 of the heater 100. FIG. 4 specifically illustrates two inlet manifolds 204I and three outlet manifolds 204O with 24 total coils 100 connected therebetween in a non-limiting example. The open circles in the coils 100 represent fluid flow into the coils 100 (i.e., fluid flow in a direction into the page) and the shaded circles represent fluid flow out of coils 100 (i.e., fluid flow in a direction out of the page) through single and/or double tubes, as above. The tubes and/or coils 100 can have a horizontal or vertical layout in the heater 200 depending on the intended application and process requirements, such as self-draining, single-phase flow or two-phase flow, and available plot space.

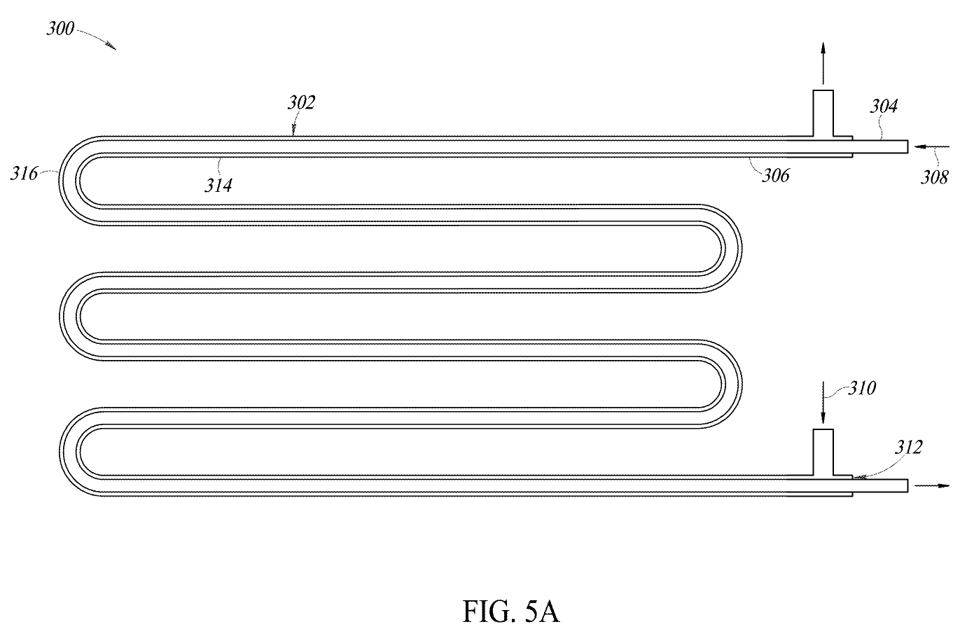

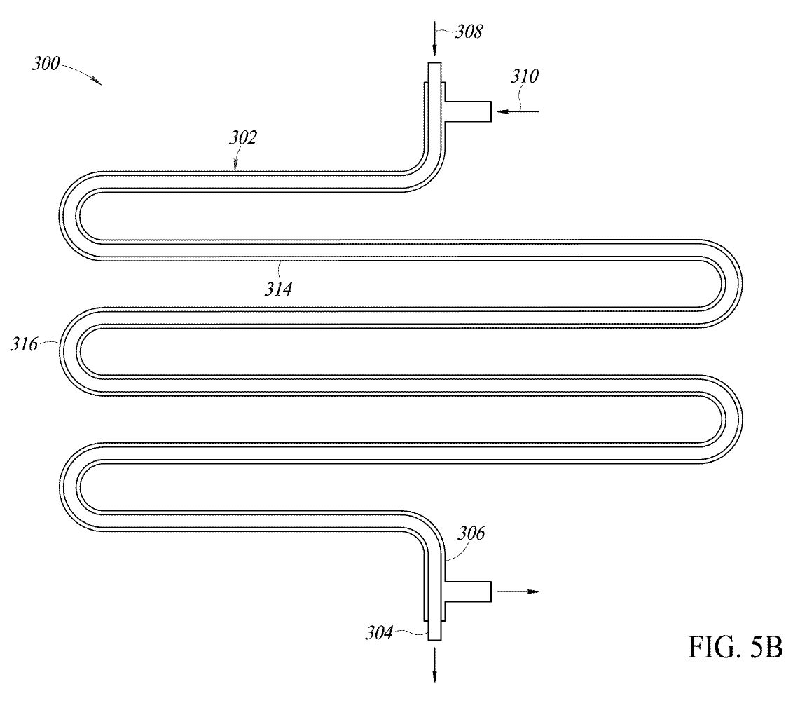

As alluded to above, the present disclosure contemplates heaters and heat exchangers that are capable of processing high viscosity feed stock or high viscosity process fluids in laminar flow (or flow with a low Reynold’s number) at low flow velocities by reducing the film temperature while maintaining acceptable or desirable process pressure drop. The above non-limiting examples are directed to a heater and/or coils for a heater. FIGS. 5A-8 are views of implementations of a heat exchanger employing the techniques of the disclosure to achieve the above and other advantages. Starting with FIGS. 5A and 5B, illustrated in both figures is a heat exchanger 300 with a double tube 302 including a first or inner tube 304 and a second or outer tube 306. As with the coils 100 described above, the inner tube 304 is inside of the outer tube 306 and both tubes 304, 306 generally have the same shape and configuration, although the inner tube 304 is smaller to fit inside the outer tube 306.

A first fluid 308 flows inside of and through the inner tube 304 and a second fluid 310 flows through a gap or space 312 between an outer surface of the inner tube 304 and an inner surface of the outer tube 306. The gap or space 312 can have the dimensions described above for the gap or space 106. In this way, the outer tube 306 acts as a “shell” in a shell and tube heat exchanger with the second fluid 310 being shell-side flow and the first fluid 308 being tube-side flow inside of the inner tube 304, thus enabling indirect heat transfer between the fluids 304, 306 meaning that the fluids do not contact each other yet still transfer heat between the fluids. The outer tube 306 can be distinguished from a typical shell in a shell and tube exchanger most notably by size, as the tube 306 has a diameter that is typically 5 inches or less whereas a shell of a shell and tube heat exchanger may have a diameter in the range of at least a meter, if not 10 or more meters. In addition, a shell of a shell and tube heat exchanger surrounds and encloses a bundle of tubes whereas the outer tube 306 surrounds and encloses only a single tube, namely, inner tube 304. As such, the heat exchanger 300 employs a similar concept to a shell and tube heat exchanger at a smaller scale and for each tube individually rather than for a bundle of tubes to assist in providing the benefits described herein.

Heat is generally transferred from the higher temperature fluid to the lower temperature fluid. The higher temperature fluid can be either of the first fluid 308 or the second fluid 310. In some implementations, and as shown in FIGS. 5A and 5B, the double tube 302 does not have jump-overs or flanges, but rather, includes straight tube sections 314 interconnected by return headers 316 or return bends 316. The return headers 316 can have any of the features described above for the return header 115 of FIG. 1C. As a result, the double tube 302 defines a single flow path through both of the inner and outer tubes 304, 306 and return headers 316 that is a serpentine arrangement where the flow changes to an opposite direction after every return header 316. Where the double tube 302 has multiple passes (i.e., multiple straight sections 314 interconnected by multiple return headers 316), this results in parallel fluid flow in two opposite directions in the various passes, meaning flow from left to right along several passes and flow from right to left along several passes in the orientation of the heat exchanger 300 shown in FIGS. 5A and 5B.

The tubes 304, 306 may have different nominal diameters than the return bends 316. Further, the tubes 304, 306 and fittings may have the same or different diameters from each other in the various passes depending upon the heat transfer requirement and fluid pressure drops. In other words, the straight sections 314 and/or the return bends 316 may vary in diameter such that the fluids 308, 310 flow through tubes 304, 306 with different diameters. The tube length meaning the length of the straight sections 314 of the tubes 304, 306 of each pass (i.e., each straight section) may also be the same or different. FIG. 5A and 5B further show the double tube 302 has tubular return bends 316 that match the straight tubes 304, 306. The return bends 316 can be a tubular type or any other type that will connect the upstream and/or downstream straight tubes 304, 306. The return bends 316 can also be a type of plug header that allows inspection spaces between the inner and outer tubes 304, 306 in some non-limiting examples.

FIG. 5A specifically shows an arrangement where the first fluid 308 is introduced to the inner tube 304 at a top of the heat exchanger 300 and double tube 302 while the second fluid 310 is introduced at a bottom of the heat exchanger 300 and double tube 302 in the orientation shown. In other words, the fluids 308, 310 are introduced at opposite ends of the overall flow path defined by the double tube 302. As a result, flow of the fluids 308, 310 through the heat exchanger 300 is countercurrent in the sense that the fluids 308, 310 flow in generally opposite directions through the heat exchanger 300. For example, when the first fluid 308 is flowing to the left in the arrangement of FIG. 5A, the second fluid 310 is flowing to the right and so on. Further, FIG. 5A illustrates that the double tube 302 includes comparatively longer straight sections 314 to increase residence time in the heat exchanger 300 which can assist with heat transfer.

FIG. 5B illustrates an alternative arrangement where the first and second fluids 308, 310 are both introduced at the top of the heat exchanger 300 or the same end of the flow path of the double tube 302 such that the fluids 308, 310 flow in the same direction through the heat exchanger 300. Notably, the flow of the fluids 308, 310 can be selected to be introduced at either end of the flow path through the double tube 302 or at any point along the flow path of the double tube 302. Further, FIG. 5B illustrates that the straight sections 314 of the double tube 302 can also be selected to be comparatively shorter depending on available space and other design factors. Thus, the double tube 302 is not limited in size or length of the straight sections 314 of the double tube 302 and the overall size or length of the double tube 302 in general. Further, the double tube 302 can be manufactured as a single piece by inserting the inner tube 304 into the outer tube 306 and bending both the inner tube 304 and outer tube 306 to the same radius at the return bends 316 or the double tube 302 can be assembled with the straight sections of the tubes 304, 306 as separate components from the return bends 316 and the straight sections 314 and return bends 316 are coupled together in a fluid tight seal, such as by welding or with a flanged connection, etc.

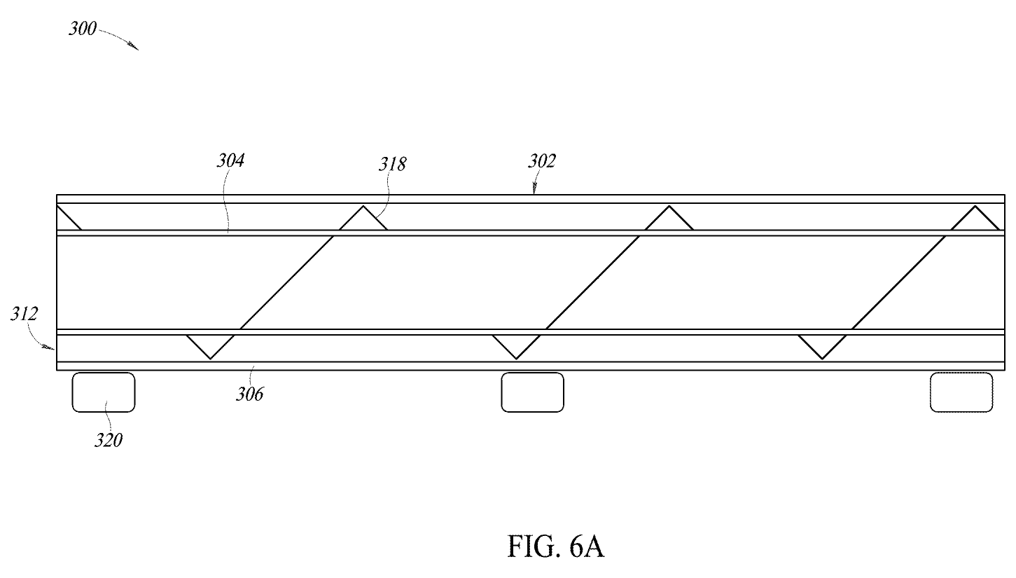

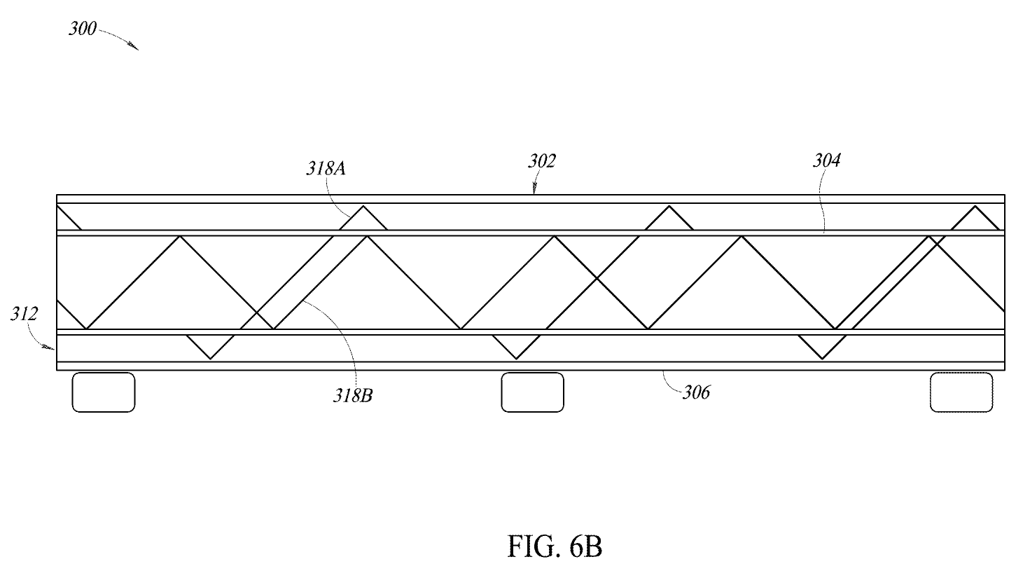

FIGS. 6A and 6B illustrate that the heat exchanger 300 and double tube 302 can also include spiral fins 318 similar to the coils 100. With reference to both FIGS. 6A and 6B, fins 318 enhance heat transfer by inducing spiral flow that disrupts the formation of a boundary layer and creates a homogeneous mixture of fluid of a similar temperature. The fins 318 may have any of the features of the fins 132 described above with reference to FIG. 2D. The configuration of the fins 318 can be arranged counterclockwise or clockwise to induce clockwise or counterclockwise spiral flow. The pitch of the fins 318 can be constant or may vary between fins 318 based on the heat transfer needs. The geometry of the fins 318 can be flat, round or any other shape. The fins 318 can also be continuous along an entire length of the tubes 304, 306, and in particular, along the straight sections 314 of the tubes 304, 306, or the tins 318 can be provided only in certain sections of the double tube 302. The fins 318 can be a single spiral arrangement or multiple parallel spiral arrangement, meaning fins 318 arranged to induce a single spiral flow, or multiple spiral flows all in the same direction (i.e., double helix, triple helix, etc.). FIGS. 6A and 6B also illustrate that the double tube 302 can have supports 320 coupled to the double tube 302 at selected intervals to support the double tube 302, reduce vibration, and provide other benefits.

Turning to FIG. 6A specifically, illustrated therein is the heat exchanger 300 and double tube 302 with only spiral fins 318 between the inner and outer tubes 304, 306 and located in the space or gap 312. In this arrangement, the fins 318 can have any of the features and/or dimensions described above for fins 132. With reference to FIG. 6B, illustrated therein is the double tube 302 with fins 318A in the gap or space 312 between the inner and outer tubes 304, 306 as well as fins 318B inside the inner tube 304 to induce spiral flow of both fluids 308, 310 (FIG. 5A). The fins 318A, 318B can have the same arrangement and rotation to induce spiral flow in the same direction (i.e., clockwise or counterclockwise) or can have a different arrangement and rotation to induce spiral flow in opposite directions (i.e., clockwise and counterclockwise).

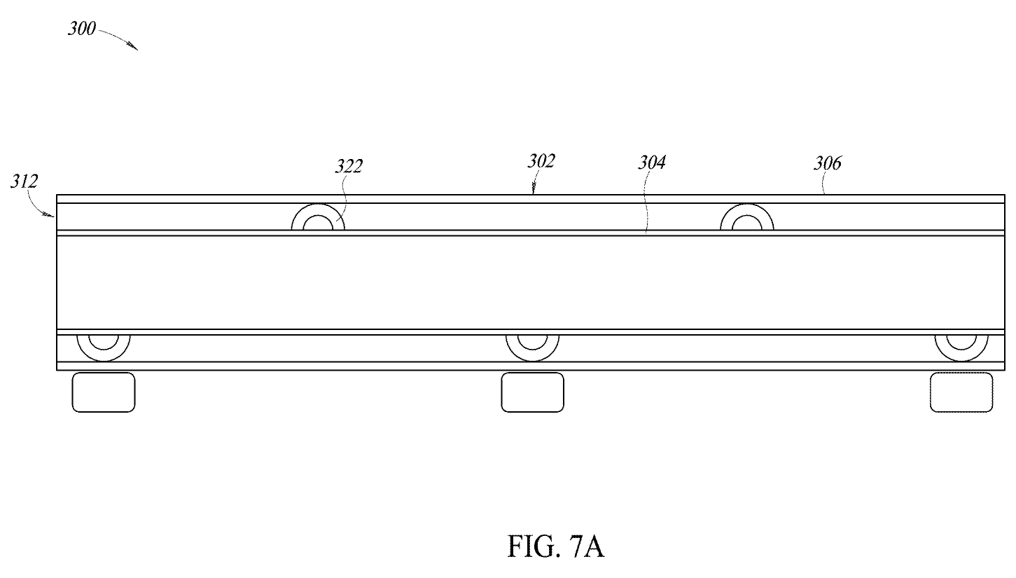

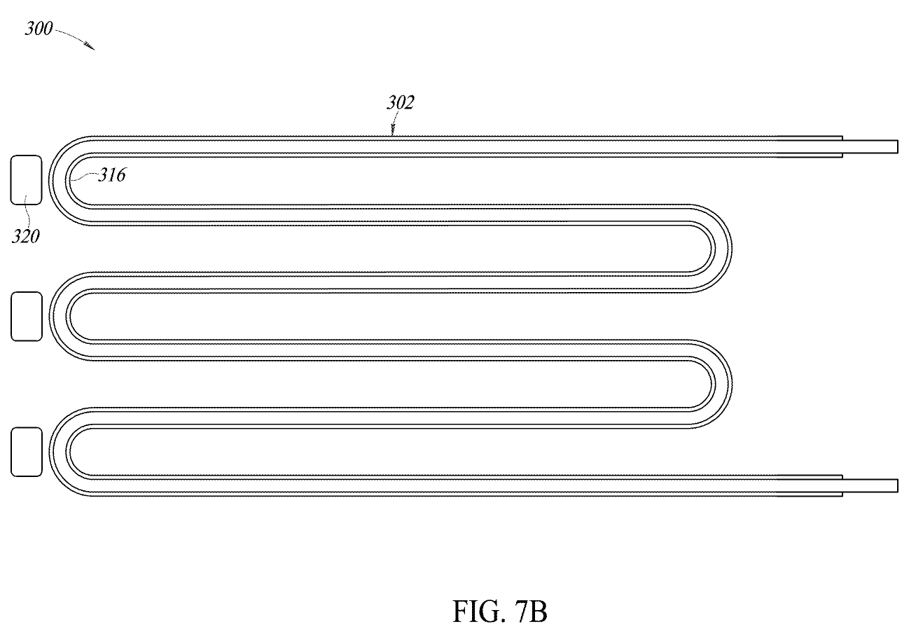

FIG. 7A is a schematic view of the heat exchanger 300 with spacers 322 between the inner and outer tubes 304, 306. The spacers 322 are coupled to the inner tube 304 and/or the outer tube 306 and are positioned in the space or gap 312 between tubes 304, 306. The spacers 322 assist with maintaining a proper position of the inner tube 304 relative to the outer tube 306. When the inner and outer tubes 304, 306 have different operating temperatures or the material composition of the tubes 304, 306 is different, the inner and outer tubes 304, 306 may experience different thermal expansion during operation that will lead to different amount of movement due to thermal conditions. The spacers 322 assist with countering such differential thermal expansion and ensuring that the space or gap 312 has a consistent size for the flow of fluid during operation. Inclusion of the spacers 322 may result in additional longitudinal thermal expansion since radial thermal expansion is constrained by the spacers 322, in which case, the design of the heat exchanger can account for such longitudinal thermal expansion, such as by leaving additional space between the tubes and any enclosure surrounding the tubes or by changing the characteristics of the return bends 316 (FIG. 5A).

The spacers 322 can be provided in a selected number and spacing relative to each other. For example, the spacers 322 can be provided at a spacing from each other that can be selected to be any value to two decimal places from 1 inch to 36 inches. Thus, for purposes of original disclosure, the spacing between spacers 322 can be 2.5 inches as well as 12.25 inches, among other possibilities. The spacers 322 can each have identical or equidistant spacing relative to each other as well as different spacing relative to each other in a single pass or in different passes. Thus, the spacers 322 of one pass can have varying spacing, or each pass may have the spacers 322 at the same spacing which is different from the spacing of the spacers 322 in a different pass based on anticipated differential thermal expansion at different locations in the heat exchanger 300 and fluid flow path through the heat exchanger 300 (i.e., more spacers 322 may be needed where fluid flow is hotter and thus more thermal expansion is expected to occur). Although the spacers 322 are illustrated as being located in the straight section 314 of the tubes 304, 306 in FIG. 7A, the spacers 322 can also be applied to or located in the return bends 316 to counter thermal expansion that might result in the inner tube 304 expanding against the outer tube 306 and restricting fluid flow at the return bends 316.

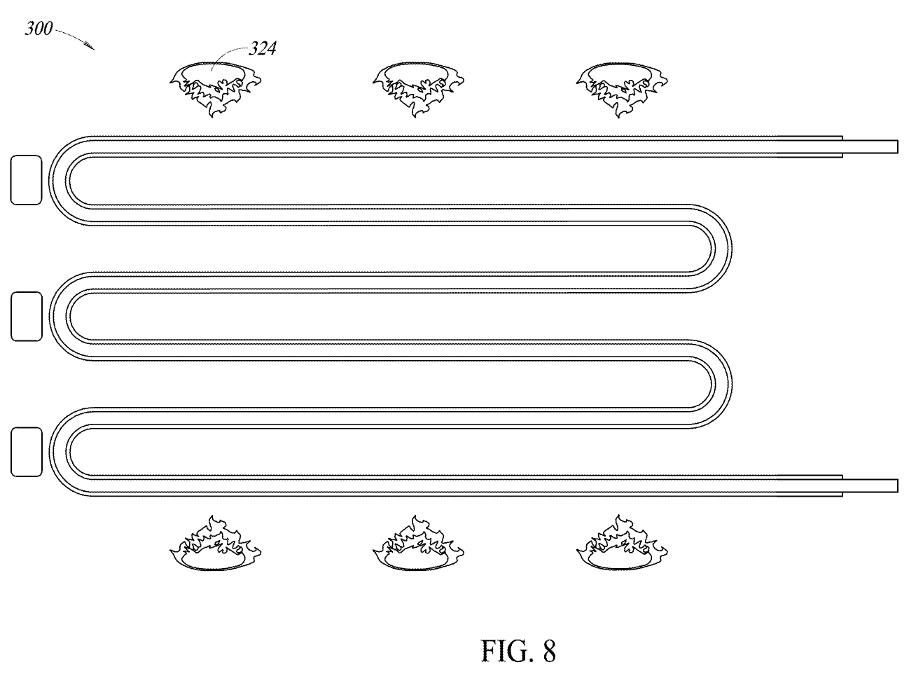

FIG. 7B is a schematic view of the heat exchanger 300 of either of FIGS. 5A and 5B with tube supports 320 supporting the double tubes 302. As noted above, tube supports 320 can be provided along the straight sections 314 of the tubes 304, 306 (FIG. 6A). Tube supports 320 can also be provided at the return bends 316 to counter differential thermal expansion in the longitudinal direction of the tubes 304, 306 as well as prevent the inner tube 304 from expanding into the outer tube 306. The above examples in FIGS. 5A-7B consider heat input only from indirect heat transfer between the fluids 308, 310 (FIG. 5A). The disclosure also considers adding external heat input. FIG. 8 is a schematic view of the heat exchanger 300 with such external heat input to the heat exchanger 300. Specifically, the heat exchanger 300 may receive external heat input from heat source 324, which can be any of the heat sources described herein, including at least fuel firing, electricity, thermal fluid, hybrid heat input from fuel firing and electricity or any combination of two heat sources, or any combination thereof. Thus, the heat exchanger 300 in FIG. 8 transfer heat between the fluids 308, 310 (FIG. 5A) through indirect heat exchange as well as receives heat input to at least one or both fluids 308, 310 from the external heat sources 324 to enable further temperature control and heating configurations. Although the above non-limiting examples highlight specific features in different figures and also apply the concepts of the disclosure to a heater and a heat exchanger, it should be noted that the present disclosure contemplates any of the above concepts used alone or in combination. As some non-limiting examples, the tube supports 320 and spacers 322 described with reference to the heat exchanger 300 can also be used for the coils 100 and the heat sources described for external heating of the coils 100 can also be applied to the heat exchanger 300. Thus, for purposes of original disclosure, implementations of the disclosure include any of the disclosed features alone or in combination.

In view of the above, the concepts of the disclose provide for a double tube coil and/or double tube heat exchanger that offer a large amount of heating surface area and large equivalent hydraulic diameter while minimizing thickness of the laminar flow boundary. In addition, the concepts of the disclosure provide for access to internals for surface cleaning in the event of fouling, thus further reducing costs. The heater designs discussed herein will provide a higher heat transfer coefficient and need less heating surface to meet process requirements than conventional designs. The double tube configuration allows for higher average heat flux and less parallel streams such that overall, the design is more compact and will have less and simplified maintenance. Such benefits are particularly advantageous for heating high viscosity fluids and/or fluids that are temperature sensitive and thus benefit from close temperature control.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the heater or heat exchanger context, and are not limited to the example heater or heat exchanger systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with heater or heat exchanger devices, systems, and methods have not been described in detail to avoid unnecessarily obscuring the descriptions of the implementations of the present disclosure.

Throughout the specification, claims, and drawings, the following terms take the meaning explicitly associated herein, unless the context clearly dictates otherwise. As used throughout this document, including the claims, the singular form “a”, “an”, and “the” include plural references unless indicated otherwise. Any of the features and elements described herein may be singular, e.g., a tube may refer to one tube. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, steel, and the like, either alone or in any combination.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Application No. 63/785,981, filed April 9, 2025 and U.S. Provisional Application No. 63/792,045, filed April 21, 2025, are incorporated herein by reference, in their entirety. Aspects of the embodiments can be modified, if necessary to employ concepts of the various patents, applications and publications to provide yet further embodiments.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A heat transfer assembly for a heater or a heat exchanger, comprising:
a first tube;
a second tube received within the first tube;
a space between the first tube and the second tube; and
a heat source,
wherein a process fluid is configured to flow through the space between the first tube and the second tube and receive heat input from the heat source.

2. The heat transfer assembly of claim 1, wherein the heat source is fuel firing, electricity, thermal, or a combination thereof, or
wherein a viscosity of the process fluid is at least 20 cP.

3. The heat transfer assembly of claim 1, wherein the heat source includes a first heating element and a second heating element being the same type of heating element or a different type of heating element.

4. The heat transfer assembly of claim 1, wherein the first tube is coupled to the second tube with a flanged connection or a welded connection.

5. The heat transfer assembly of claim 1, wherein the second tube includes a first section and a second section, the heat transfer assembly further comprising:
a conduit between the first section and the second section of the second tube, wherein the process fluid is configured to flow through the conduit.

6. The heat transfer assembly of claim 1, wherein the heat source is an electrical heating element.

7. The heat transfer assembly of claim 1, wherein the heat source includes a first heating element being an electrical heating element and a second heating element being a non-electrical heating element; or
wherein the second heating element is an electrical heating element and the first heating element is a non-electrical heating element.

8. The heat transfer assembly of claim 1, wherein the process fluid is a first process fluid with, the heat transfer assembly further comprising:
a second process fluid configured to flow through the first tube, wherein the heat source is indirect heat transfer between the first process fluid and the second process fluid.

9. The heat transfer assembly of claim 1, further comprising:
a spiral vane in the space or in the second tube, or both.

10. A heat transfer assembly for a heater or a heat exchanger, comprising:
a double tube including an outer tube and inner tube received inside of the outer tube, the double tube configured to convey a process fluid; and
a heat source,
wherein the process fluid is configured to receive heat input from the heat source.

11. The heat transfer assembly of claim 10, further comprising;
a gap between the outer tube and the inner tube, wherein the process fluid is configured to flow through the gap,
wherein the heat source is an external heat source.

12. The heat transfer assembly of claim 11, wherein the external heat source is from fuel firing, electricity, thermal energy, or a combination thereof.

13. The heat transfer assembly of claim 10, wherein the process fluid is a first process fluid and the double tube is configured to convey the process fluid through a space between the outer tube and the inner tube, the assembly further comprising:
a second process fluid configured to flow through the inner tube, wherein the heat source is indirect heat transfer between the first process fluid and the second process fluid.

14. The heat transfer assembly of claim 10, wherein the double tube is one of a plurality of double tubes, the plurality of double tubes coupled to each other through jump-overs or return bends.

15. The heat transfer assembly of claim 10, further comprising:
a spiral vane between the outer tube and the inner tube or inside the inner tube, or both.

16. A heating method, comprising:
heating a process fluid in an interior space of a double tube assembly, including heating the process fluid by inputting heat to the process fluid from a heat source.

17. The heating method of claim 16, wherein the internal space is a space between an outer tube and an inner tube of the double tube assembly and heat source includes a first heat source and a second heat source, and
wherein heating the process fluid includes alternatively heating the process fluid with only the first heat source or only the second heat source at different times.

18. The heating method of claim 17, wherein heating the process fluid includes simultaneously heating the process fluid with both the first heat source and the second heat source.

19. The heating method of claim 16, wherein the interior space includes both a space between an outer tube and an inner tube of the double tube assembly and an inside of the inner tube, and
wherein inputting heat to the process fluid from the heat source includes indirectly transferring heat between the process fluid flowing through the space and the process fluid flowing inside of the inner tube.

20. The heating method of claim 16, further comprising:
inducing a spiral flow of the process fluid with a spiral vane in the interior space.
